(19) United States
(12) Patent Application Publication
(10) Pub. No.: US 2010/0202532 A1
(43) Pub. Date: Aug. 12, 2010

(54) MULTI-FRAME MOTION EXTRAPOLATION FROM A COMPRESSED VIDEO SOURCE

(75) Inventor: Richard W. Webb, McKinney, TX (US)

Correspondence Address: Dolby Laboratories Inc., 999 Brannan Street, San Francisco, CA, 94103, US

(73) Assignee: Dolby Laboratories Licensing Corporation

(21) Appl. No.: 12/449,887

(22) PCT Filed: Feb. 25, 2008
(86) PCT No.: PCT/US2008/002421

§ 371 Date: Apr. 15, 2010

Related U.S. Application Data
(60) Provisional application No. 60/906,074, filed on Mar. 9, 2007.

(51) Int. Cl. H04N 7/26

(52) U.S. Cl. 375/240.16; 375/E07.123

(57) ABSTRACT

Motion vectors are important to many video signal processing techniques that are applied to video data streams such as MPEG 2 compliant video data streams. The performance of these techniques can often be improved if larger numbers of motion vectors are available. Two techniques are disclosed that may be used to derive a significant number of additional motion vectors from the original motion vectors that exist in an encoded video data stream. A motion vector reversal technique derives new motion vectors representing motion in directions opposite to that represented by original motion vectors. A vector tracing technique derives new motion vectors from combinations of original motion vectors.

### TECHNICAL FIELD

The present invention pertains generally to video signal processing and pertains more specifically to signal processing that derives information about apparent motion in images represented by a sequence of pictures or frames of video data in a video signal.

### BACKGROUND ART

A variety of video signal processing applications rely on the ability to detect apparent motion in images that are represented by a sequence of pictures or frames in a video signal. Two examples of these applications are data compression and noise reduction.

Some forms of data compression rely on the ability to detect motion between two pictures or frames so that one frame of video data can be represented more efficiently by inter-frame encoded video data, or data that represents at least a portion of one frame of data in relative terms to a respective portion of data in another frame. One example of video data compression that uses motion detection is MPEG-2 compression, which is described in international standard ISO/IEC 13818-2 entitled “Generic Coding of Moving Pictures and Associated Audio Information: Video” and in Advanced Television Standards Committee (ATSC) document A/54 entitled “Guide to the Use of the ATSC Digital Television Standard.” The MPEG-2 technique compresses some frames of video data by spatial coding techniques without reference to any other frame of video data to generate respective I-frames of independent or intra-frame encoded video data. Other frames are compressed by temporal coding techniques that use motion detection and prediction. Forward prediction is used to generate respective P-frames or predicted frames of inter-frame encoded video data, and forward and backward prediction are used to generate respective B-frames or bidirectional frames of inter-frame encoded video data. MPEG-2 compliant applications may select frames for intra-frame encoding according to a fixed schedule, such as every fifteenth frame, or they may select frames according to an adaptive schedule. An adaptive schedule may be based on criteria related to the detection of motion or differences in content between adjacent frames, if desired.

Some noise-reduction techniques rely on the ability to identify portions of an image in which motion occurs or, alternatively, portions in which no motion occurs. One system for noise reduction uses motion detection to control the application of a temporal low-pass filter to corresponding picture elements or “pixels” in respective frames in a sequence of frames. This form of noise reduction avoids blurring the appearance of moving objects by applying its low-pass filter to only those areas of the image in which motion is not detected. One implementation of the low-pass filter calculates a moving average value for corresponding pixels in a sequence of frames and substitutes the average value for the respective pixel in the current frame.

MPEG-2 compression uses a motion vector for inter-frame encoding to represent motion between two frames of video data. The MPEG-2 motion vector expresses the horizontal and vertical displacement of a region of a picture between two different pictures or frames.

The performance of the compression and noise reduction applications mentioned here generally improves as the number of motion vectors increases for a given sequence of frames.

Several methods have been developed to derive motion vectors by detecting differences between frames. One well known method uses a technique called block matching, which compares the video data in a “current” frame of video data to the video data in a “reference” frame of data. The data in a current frame is divided into an array of blocks such as blocks of 16×16 pixels or 8×8 pixels, for example, and the content of a respective block in the current frame is compared to arrays of pixels within a search area in the reference frame. If a match is found between a block in the current frame and a region of the reference frame, motion for the portion of the image represented by that block can be deemed to have occurred.

The search area is often a rectangular region of the reference frame having a specified height and width and having a location that is centered on the corresponding location of the respective block. The height and width of the search area may be fixed or adaptive. On one hand, a larger search area allows larger magnitude displacements to be detected, which correspond to higher velocities of movement. On the other hand, a larger search area increases the computational resources that are needed to perform block matching.

An example may help illustrate the magnitude of the computational resources that can be required for block matching. In this example, each frame of video data is represented by an array of 1080×1920 pixels, and each frame is divided into blocks of 8×8 pixels. As a result, each frame is divided into an array of 32,400=135×240 blocks. The search area is centered on the location of the respective block to be matched and is 64 pixels high and 48 pixels wide. In one implementation, each pixel in a block is compared to its respective pixel in all 8×8 sub-regions of the search area. In this example, the search area for blocks away from the edge of the image has 2240=56×48 sub-regions; therefore, more than 143K pixel comparisons are needed to check for motion of a single block. Fewer comparisons are needed for blocks at or near the edge of the image because the search area is bounded by the edge of the image. Nevertheless, nearly 4.5×10⁹ pixel comparisons are needed for each frame. If the frame is part of a video data stream that presents its data at a rate of sixty frames per second, then more than 267×10⁹ pixel comparisons must be performed each second just to compare pixels in adjacent frames.

A correspondingly higher number of comparisons are needed if block matching is to be done for a larger number of frames including pairs of frames that are not adjacent to one another but are instead separated by larger temporal distances. The implementation of some systems incorporates processing hardware with pipelined architectures to obtain higher processing capabilities for lower cost but even these lower costs are too high for many applications. Optimization techniques have been proposed to reduce the computational requirements of block matching but these techniques have not been as effective as desired because they require conditional logic that disrupts the processing flow in processors that have a pipelined architecture.

### DISCLOSURE OF INVENTION

It is an object of the present invention to provide for an efficient way to obtain a large number of motion vectors for video data that is arranged in a sequence of pictures or frames.

In this context and throughout the remainder of this disclosure, the term “motion vector” refers to any data construct that can be used by inter-frame encoding to represent at least a portion of one frame of data in relative terms to a respective portion of data in another frame, which typically expresses motion between two frames of video data. The term is not limited to the precise construct set forth in the MPEG-2 standard as described above. For example, the term “motion vector” includes the variable block-size motion compensation data constructs set forth in part 10 of the ISO/IEC 14496 standard, also known as MPEG-4 Advanced Video Coding (AVC) or the ITU-T H.264 standard. The MPEG-2 standard does provide a useful example for this disclosure. The motion vector defined in the MPEG-2 standard specifies a source area of one image, a destination area in a second image, and the horizontal and vertical displacements from the source area to the destination area. Additional information may be included in or associated with a motion vector. For example, the MPEG-2 standard sets forth a data construct with differences or prediction errors between the partial image in the source area and the partial image in the destination area that may be associated with a motion vector.

One aspect of the present invention teaches receiving one or more signals conveying a sequence of frames of video information, where the video information includes intra-frame encoded video data and inter-frame encoded video data representing a sequence of images; analyzing inter-frame encoded video data in one or more of the frames to derive new inter-frame encoded video data; and applying a process to at least some of the video information to generate modified video information representing at least a portion of the sequence of images, where the process adapts its operation in response to the new inter-frame encoded data. This aspect of the present invention is described below in more detail.

The various features of the present invention and its preferred embodiments may be better understood by referring to the following discussion and the accompanying drawings. The contents of the following discussion and the drawings are set forth as examples only and should not be understood to represent limitations upon the scope of the present invention.

### BRIEF DESCRIPTION OF DRAWINGS

FIG. 1 is a schematic block diagram of an exemplary system that incorporates various aspects of the present invention.

FIG. 2 is a schematic illustration of a sequence of pictures or frames of video data in an MPEG-2 compliant encoded video data stream.

FIG. 3 is a schematic diagram of two frames of video data.

FIGS. 4A-4B are schematic illustrations of three frames of video data with original and new motion vectors.

FIG. 5 is a schematic illustration of frames with original and new motion vectors.

FIG. 6 is a schematic illustration of frames in a GOP with original motion vectors.

FIG. 7 is a schematic illustration of new motion vectors that can be derived from original motion vectors using the vector reversal technique.

FIG. 8 is a schematic illustration of original motion vectors and new motion vectors derived for frames in a GOP.

FIG. 9 is a schematic block diagram of a device that may be used to implement various aspects of the present invention.

### MODES FOR CARRYING OUT THE INVENTION

### A. Introduction

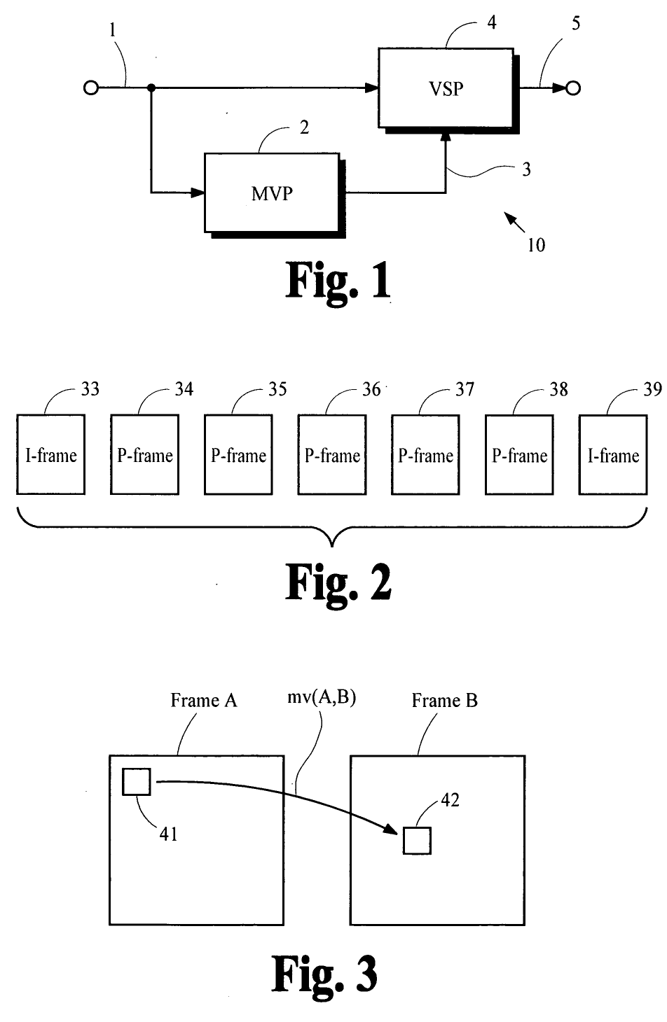

FIG. 1 is a schematic block diagram of an exemplary system 10 incorporating aspects of the present invention that derives “new” motion vectors from “original” motion vectors that already exist in an encoded video data stream. The Motion Vector Processor (MVP) 2 receives video information conveyed in an encoded video data stream from the signal path 1, analyzes the original motion vectors present in the data stream to derive the new motion vectors that are not present in the stream, passes the new motion vectors along the path 3 and may, if desired, also pass the original motion vectors along the path 3. The Video Signal Processor (VSP) 4 receives the encoded video data stream from the path 1, receives the new motion vectors from the path 3, receives the original motion vectors from either the path 1 or the path 3, and applies signal processing to at least some of the video information conveyed in the encoded video data stream to generate a processed signal that is passed along the signal path 5. The VSP 4 adapts its signal processing in response to the new motion vectors. Preferably, the VSP 4 adapts its signal processing in response to the original motion vectors as well as the new motion vectors. Essentially any type of signal processing may be applied as may be desired. Examples of signal processing include noise reduction, image resolution enhancement and data compression. No particular process is essential.

By using existing motion vectors as the basis of its processing, the present invention is able to derive new motion vectors very efficiently. This process is efficient enough to permit the derivation of a much larger number of motion vectors than could be obtained using known methods.

The present invention can process motion vectors in an MPEG-2 compliant stream, for example, to derive motion vectors for every pair of frames in sequence of video frames known as a Group of Pictures (GOP). Motion vectors can be derived for I-frames and for pairs of frames that are not adjacent to one another. Motion vectors can also be derived for frames that are in a different GOP.

Implementations of the present invention tend to be self-optimizing because more processing is applied to those video frames where greater benefits are more likely achieved. Fewer computational resources are used in situations where additional motion vectors are less likely to provide much benefit. This is because more processing is needed for frames that have more original motion vectors, more original motion vectors exist for those pairs of frames where more motion is detected, and greater benefits are generally achieved for frames in which more motion occurs.

### B. Motion Vector Reversal

FIG. 2 is a schematic illustration of a sequence of pictures or frames of video data in an MPEG-2 compliant encoded video data stream. This particular sequence includes two I-frames 33, 39 and five intervening P-frames 34 to 38. The encoded data in each P-frame may include one or more motion vectors for blocks of pixels in that frame, which are based on or predicted from corresponding arrays of pixels in the immediately preceding frame. The P-frame 34, for example, may contain one or more motion vectors representing blocks in motion between the I-frame 33 and the P-frame 34. The P-frame 35 may contain one or more motion vectors representing blocks in motion between the P-frame 34 and the P-frame 35.

All motion vectors that are present in this encoded video data stream are confined to represent motion from an I-frame or a P-frame to an adjacent P-frame that follows. This particular sequence of frames does not have any motion vectors that represent motion from any of the frames to a subsequent I-frame, from any of the frames to a preceding frame, or between any two frames that are not adjacent to one another.

Systems and methods that incorporate aspects of the present invention are able to derive motion vectors like those described in the previous paragraph that do not exist in the existing encoded data stream. This may be done using two techniques referred to here as motion vector reversal and motion vector tracing. The motion vector reversal technique is described first.

FIG. 3 is a schematic diagram of two frames of video data within a sequence of frames. In this example, Frame A is an 1-frame and Frame B is a P-frame in an MPEG-2 compliant data stream. As illustrated, Frame B includes an original motion vector that represents motion that occurs from a source area 41 in Frame A to a destination area 42 in Frame B. This motion vector is denoted as mv(A,B), which represents the magnitude and direction of motion and the area of the image that has moved. In an MPEG-2 compliant data stream, for example, the magnitude and direction of motion are represented by numbers expressing horizontal and vertical displacement and the area of motion is specified by the destination area in Frame B, which is one of a plurality of blocks of pixels that lie on a defined grid in Frame B. As mentioned above, this particular data construct for the motion vector is not essential to the present invention.

Frame B may have more than one motion vector representing motion occurring in multiple areas from Frame A to Frame B. All of these motion vectors are collectively denoted herein as MV(A,B).

No frame in the data stream has a motion vector that represents motion from Frame B to Frame A, which is denoted as mv(B,A), but the present invention is able to derive a motion vector in the reverse direction by exploiting the realization that when a motion vector mv(A,B) exists that defines a relationship from an area in Frame A to an area in Frame B, a complementary or reverse relationship exists from the area in Frame B to the area in Frame A. The motion from Frame B to Frame A is the reverse of the motion from Frame A to Frame B, which can be represented as:

mv(B,A)=Reverse[mv(A,B)]. (1)

The reverse of the collection of all motion vectors for a frame can be expressed as:

MV(B,A)=Reverse[MV(A,B)]. (2)

The notation Reverse[ ] is used to represent a function or operation that derives from a respective motion vector another motion vector that represents the same magnitude of motion but in the opposite direction. The area of motion for each motion vector may be specified as desired. For this particular example, the area of motion expressed by the new motion vector is the destination area in Frame A. This could be expressed by horizontal and vertical pixel offsets of the upper-left corner of the area relative to the upper-left corner of the image in Frame A. Fractional pixel offsets may be specified if desired. No particular expression is essential to the present invention.

### C. Motion Vector Tracing

Additional motion vectors can be derived by tracing motion across multiple frames. This technique allows motion vectors to be derived for frames that are not adjacent to one another.

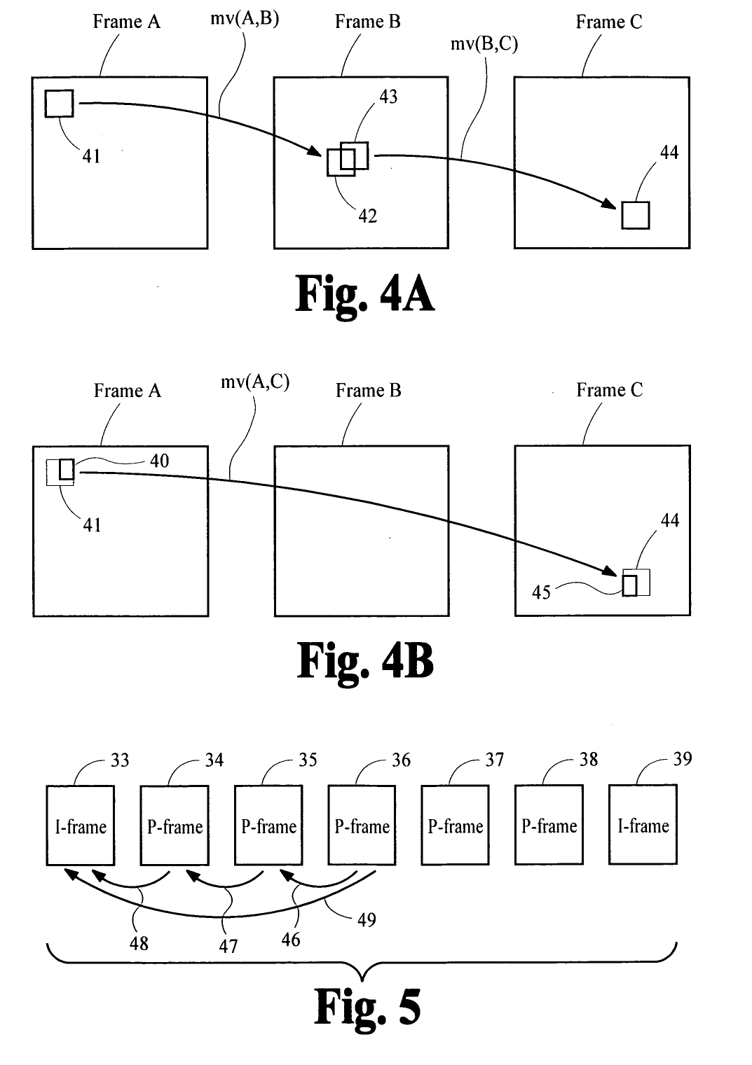

FIG. 4A is a schematic diagram of three frames of video data within a sequence of frames. The example shown in this figure adds Frame C to the example shown in FIG. 3. Frame C is a P-frame. As illustrated, Frame C includes an original motion vector that represents motion that occurs from a source area 43 in Frame B to a destination area 44 in Frame C. This motion vector is denoted as mv(B,C). If the source area in Frame B for a motion vector mv(B,C) overlaps a destination area for a motion vector mv(A,B), then a new motion vector mv(A,C) may be derived that represents motion from Frame A to Frame C. This new motion vector is illustrated schematically in FIG. 4B and is represented by the following expression:

mv(A,C)=mv(A,B)⊕mv(B,C) (3)

The vector trace of the collection of all motion vectors for a pair of frames is expressed as:

MV(A,C)=MV(A,B)⊕MV(B,C) (4)

The symbol ⊕ is used to represent a function or operation that combines two motion vectors to represent the vector sum of displacements for the two individual vectors and that identifies the proper source and destination areas for the combination.

The source area 40 in Frame A for the new motion vector mv(A,C) may be only a portion of the source area 41 for the corresponding motion vector mv(A,B). Similarly, the destination area 45 for the new motion vector mv(A,C) may be only a portion of the destination area 44 of the corresponding motion vector mv(B,C). The degree to which these two source areas 40, 41 and these two destination areas 44, 45 overlap is controlled by the degree to which the destination area 42 of motion vector mv(A,B) overlaps with the source area 43 of motion vector mv(B,C). If the destination area 42 of motion vector mv(A,B) is identical to the source area 43 of motion vector mv(B,C), then the source area 41 for motion vector mv(A,B) will be identical to the source area 40 for motion vector mv(A,C) and the destination area 45 of motion vector mv(A,C) will be identical to the destination area 44 of motion vector mv(B,C).

One way in which the vector tracing technique can be implemented is to identify the ultimate destination frame, which is Frame C in this example, and work backwards along all motion vectors mv(B,C) for that frame. This is done by identifying the source area in Frame B for each motion vector mv(B,C). Then each motion vector mv(A,B) for Frame B is analyzed to determine if it has a destination area that overlaps any of the source areas for the motion vectors mv(B,C). If an overlap is found for a motion vector mv(A,B), that vector is traced backward to its source frame. This process continues until a desired source frame is reached or until no motion vectors are found with overlapping source and destination areas.

The process of searching for area overlaps that is discussed in the preceding paragraph may be implemented using essentially any conventional tree-based or list-based sorting algorithm to put the motion vectors MV(B,C) into a data structure in which the vectors are ordered according to their source areas. One data structure that may be used advantageously in many applications is a particular two-dimensional tree structure known as a quad-tree. This type of data structure allows the search for overlaps with MV(A,B) destination areas to be performed efficiently.

If desired, portions of the video data that is adjacent to the source and destination areas of a new motion vector that is derived by vector tracing can be analyzed to determine if the source and destination areas should be expanded or contracted. In many instances, vector tracing by itself can obtain appropriate source and destination areas for a new derived motion vector; however, in other instances source and destination areas that are obtained by vector tracing may be not be optimum.

For example, suppose the original motion vectors in a sequence of frames represent a person walking from left to right. All of the interim frames would likely have motion vectors for the person's head and torso but some would not have motion vectors for the person's left arm when it disappeared behind the torso. Vector tracing along this sequence of motion vectors could derive new motion vectors for head and torso but not for the left arm even if that arm is visible in the first and last frames of the sequence spanned by vector tracing. By performing block matching for regions of the image adjacent to the source and destination areas of the motion vectors for the head and torso, it is possible the areas could be expanded or additional motion vectors added for the left arm. This process can be performed efficiently because the block matching search areas can be limited to regions immediately adjacent to the source and destination areas of the new motion vectors.

Motion vector tracing can be combined with motion vector reversal to derive new motion vectors between every frame in a sequence of frames. This is illustrated schematically in FIG. 5, where each motion vector is represented by an arrow pointing to the destination frame. For example, vector reversal can be used to derive motion vectors that represent motion from P-frame 36 to P-frame 35, from P-frame 35 to P-frame 34, and from P-frame 34 to I-frame 33. Vector tracing can be applied to these three new motion vectors to derive a motion vector that represents motion from P-frame 36 to I-frame 33. This particular example can be expressed as:

MV(36,33)=Reverse[MV(35,36)]⊕ Reverse[MV(34,35)]⊕ Reverse[MV(33,34)]

where mv(x,y) denotes a motion vector from frame x to frame y; and

x, y are reference numbers for the frames illustrated in FIG. 5.

### D. GOP Traversal

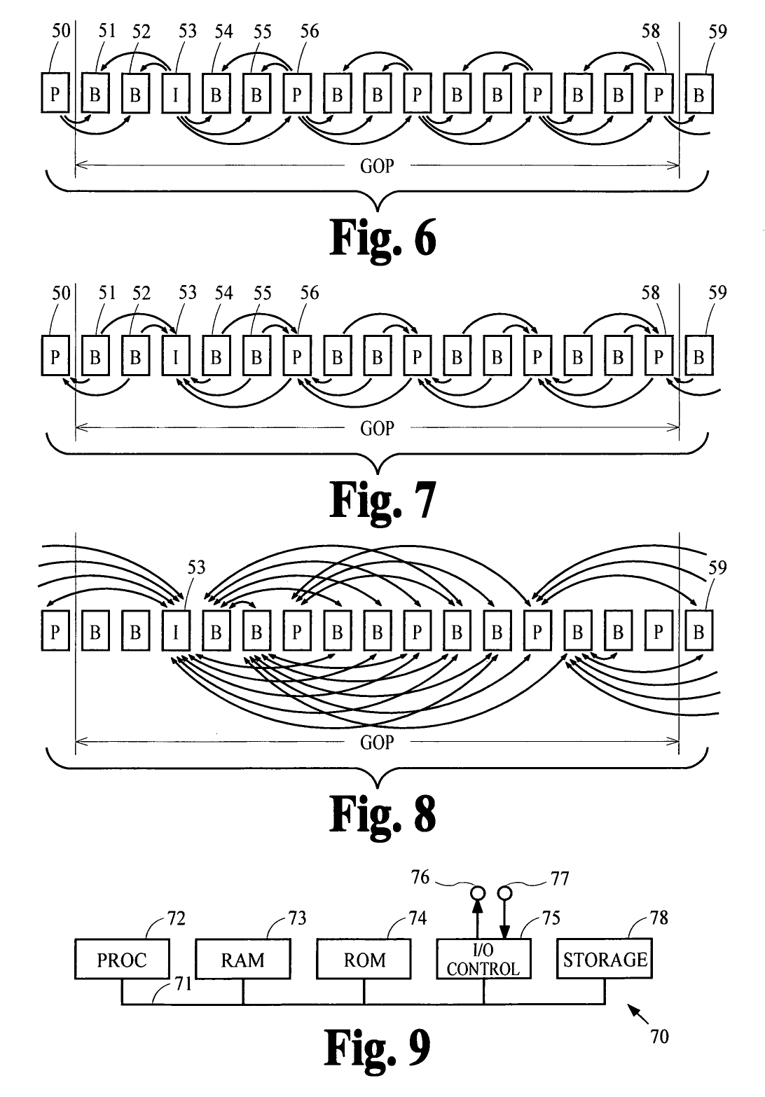

Systems that that comply with the MEPG-2 standard may arrange frames into independent segments referred to as a Group of Pictures (GOP). One common approach divides video data into groups of fifteen frames. Each GOP begins with two B-frames that immediate precede an I-frame. These three frames are followed by four sequences each having two B-frames immediately followed by a P-frame. This particular GOP arrangement is shown schematically in FIGS. 6-8 as the sequence of frames that begins with the B-frame 51 and ends with the P-frame 58. The previous GOP ends with the P-frame 50 and the subsequent GOP begins with the B-frame 59. The frames shown in this figure as well as in other figures are arranged according to presentation order rather than the order in which they occur within a data stream. The frames in an MPEG-2 compliant data stream are reordered to facilitate the recovery of B-frames from I-frames and P-frames; however, an understanding of this detail of implementation is not needed to understand principles of the present invention.

If a GOP is “open” in the sense that at least some of its frames contain original motion vectors that refer to frames in another GOP, then the present invention can derive new motion vectors that also cross the boundary between GOP. Examples of open GOP are shown in FIGS. 6-8. Referring to FIG. 6, each arrow represents an original motion vector. The head of each arrow points to its respective destination frame. For example, some of the original motion vectors represent motion from the I-frame 53 to the B-frames 54, 55 and to the P-frame 56. Some others of the original motion vectors represent motion from the P-frame 56 to the B-frames 54, 55. The two motion vectors in the P-frame 50 that cross the GOP boundary and represent motion from the P-frame 50 and the two B-frames 51, 52 are permitted because the illustrated GOP is open. By applying the vector reversal and vector tracing techniques to the bi-directional motion vectors in the B-frames, the present invention can be used to derive new motion vectors that cross GOP boundaries. This is shown in FIGS. 7 and 8.

FIG. 7 is a schematic illustration of new motion vectors that can be derived from the original motion vectors using the vector reversal technique. For example, new motion vectors can be derived that represent motion from each of the B-frames 51, 52 to the P-frame 50. These two motion vectors and two of the new motion vectors pointing to the P-frame 58 are examples of new derived motion vectors that cross a GOP boundary.

FIG. 8 is a schematic illustration of only a few of the additional motion vectors that can be derived by applying the vector tracing technique to the original and new motion vectors shown in FIGS. 6 and 7. Each arrow is bi-directional. The significant number of new motion vectors that can be derived is readily apparent. The vectors shown in the figure that point to and from the I-frame 53 and that point to and from the B-frame 59 and subsequent frames are examples of new derived motion vectors that cross a GOP boundary.

### E. Implementation

Devices that incorporate various aspects of the present invention may be implemented in a variety of ways including software for execution by a computer or some other device that includes more specialized components such as digital signal processor (DSP) circuitry coupled to components similar to those found in a general-purpose computer. FIG. 9 is a schematic block diagram of a device 70 that may be used to implement aspects of the present invention. The processor 72 provides computing resources. RAM 73 is system random access memory (RAM) used by the processor 72 for processing. ROM 74 represents some form of persistent storage such as read only memory (ROM) for storing programs needed to operate the device 70 and possibly for carrying out various aspects of the present invention. I/O control 75 represents interface circuitry to receive and transmit signals by way of the communication channels 76, 77. In the embodiment shown, all major system components connect to the bus 71, which may represent more than one physical or logical bus; however, a bus architecture is not required to implement the present invention.

In embodiments implemented by a general purpose computer system, additional components may be included for interfacing to devices such as a keyboard or mouse and a display, and for controlling a storage device 78 having a storage medium such as magnetic tape or disk, or an optical medium. The storage medium may be used to record programs of instructions for operating systems, utilities and applications, and may include programs that implement various aspects of the present invention.

The functions required to practice various aspects of the present invention can be performed by components that are implemented in a wide variety of ways including discrete logic components, integrated circuits, one or more ASICs and/or program-controlled processors. The manner in which these components are implemented is not important to the present invention.

Software implementations of the present invention may be conveyed by a variety of machine readable media such as baseband or modulated communication paths throughout the spectrum including from supersonic to ultraviolet frequencies, or storage media that convey information using essentially any recording technology including magnetic tape, cards or disk, optical cards or disc, and detectable markings on media including paper.

1. A method for deriving motion vectors for video images that comprises:
receiving a sequence of frames of video information conveyed in an encoded video data stream representing a sequence of images, wherein the encoded video data stream includes one or more original motion vectors that represent magnitude and direction of displacement from areas in images of different frames of video information;
identifying a first original motion vector that represents magnitude and direction of displacement from a first area in an image of a first frame of video information to a second area in an image of a second frame of video information;
identifying a second original motion vector that represents magnitude and direction of displacement from a third area in the image of the second frame of video information to a fourth area in an image of a third frame of video information, wherein the third area overlaps only a portion of the second area;
deriving a new motion vector not present in the video data stream from the first original motion vector and the second original motion vector, wherein the new motion vector represents magnitude and direction of displacement from a source area to a destination area in images of two frames in the sequence of frames of video information, wherein the new motion vector is derived such that either:
the source area overlaps only a portion of the first area by an amount controlled by a degree to which that portion of the second area overlaps the third area, and the destination area overlaps only a portion of the fourth area by an amount controlled by the degree to which that portion of the second area overlaps the third area, or
the source area overlaps only a portion of the fourth area by an amount controlled by the degree to which that portion of the second area overlaps the third area, and the destination area overlaps only a portion of the first area by an amount controlled by the degree to which that portion of the second area overlaps by the third area; and
applying signal processing to at least some of the video information to generate a processed signal representing a modified form of at least a portion of the sequence of images, wherein the signal processing adapts its operation in response to the new motion vector.

2. (canceled)

3. The method of claim 1 that comprises:
identifying the second original motion vector to establish the third area in the image of the second frame of video information; and
identifying the first original motion vector by identifying a motion vector in the encoded video data stream that has a destination area in the second video frame of information that overlaps the third area.

4. The method according to claim 1 that comprises:
identifying video information adjacent to the source and destination areas that can be represented by a motion vector; and
adjusting sizes of the source and destination areas to include the identified video information.

5. The method according to claim 1, wherein the video data stream conveys some of the frames of video information as intra-frame encoded data and conveys some of the frames of video information as inter-frame encoded data that comprises the original motion vectors, and wherein the destination area is in an image conveyed as intra-frame encoded data.

6. The method according to claim 1, wherein:
the sequence of video frames is arranged in groups of frames, each group having one frame conveying video information as intra-frame encoded data and a plurality of frames conveying video information as inter-frame encoded data; and
the source and destination areas are in images of two video frames in different groups of frames.

7. The method according to claim 1, wherein the signal process is any one of image noise reduction, image resolution enhancement and video data compression.

8. An apparatus for deriving motion vectors for video images, wherein the apparatus comprises:
means for receiving a sequence of frames of video information conveyed in an encoded video data stream representing a sequence of images, wherein the encoded video data stream includes one or more original motion vectors that represent magnitude and direction of displacement from areas in images of different frames of video information;
means for identifying a first original motion vector that represents magnitude and direction of displacement from a first area in an image of a first frame of video information to a second area in an image of a second frame of video information;
means for identifying a second original motion vector that represents magnitude and direction of displacement from a third area in the image of the second frame of video information to a fourth area in an image of a third frame of video information, wherein the third area overlaps only a portion of the second area;
means for deriving a new motion vector not present in the video data stream from the first original motion vector and the second original motion vector, wherein the new motion vector represents magnitude and direction of displacement from a source area to a destination area in images of two frames in the sequence of frames of video information, wherein the new motion vector is derived such that either:
the source area overlaps only a portion of the first area and the degree to which the source area overlaps the first area is controlled by the degree to which that portion of the second area overlaps the third area, and the destination area overlaps only a portion of the fourth area and the degree to which the destination area overlaps the fourth area is controlled by the degree to which that portion of the second area overlaps the third area, or
the source area overlaps only a portion of the fourth area and the degree to which the source area overlaps the fourth area is controlled by the degree to which that portion of the second area overlapped by the third area, and the destination area overlaps only a portion of the first area and the degree to which the destination area overlaps the first area is controlled by the degree to which that portion of the second area overlaps the third area; and
means for applying signal processing to at least some of the video information to generate a processed signal representing a modified form of at least a portion of the sequence of images, wherein the signal processing adapts its operation in response to the new motion vector.

9. (canceled)

10. The apparatus of claim 8 that comprises:
means for identifying the second original motion vector to establish the third area in the image of the second frame of video information; and
means for identifying the first original motion vector by identifying a motion vector in the encoded video data stream that has a destination area in the second video frame of information that overlaps the third area.

11. The apparatus according to claim 8 that comprises:
means for identifying video information adjacent to the source and destination areas that can be represented by a motion vector; and
means for adjusting sizes of the source and destination areas to include the identified video information.

12. The apparatus according to claim 8, wherein the video data stream conveys some of the frames of video information as intra-frame encoded data and conveys some of the frames of video information as inter-frame encoded data that comprises the original motion vectors, and wherein the destination area is in an image conveyed as intra-frame encoded data.

13. The apparatus according to claim 8, wherein:
the sequence of video frames is arranged in groups of frames, each group having one frame conveying video information as intra-frame encoded data and a plurality of frames conveying video information as inter-frame encoded data; and
the source and destination areas are in images of two video frames in different groups of frames.

14. The apparatus according to claim 8, wherein the signal process is any one of image noise reduction, image resolution enhancement and video data compression.

15. A medium recording a program of instructions for execution by a device to perform a method for deriving motion vectors for video images, wherein the method comprises:
receiving a sequence of frames of video information conveyed in an encoded video data stream representing a sequence of images, wherein the encoded video data stream includes one or more original motion vectors that represent magnitude and direction of displacement from areas in images of different frames of video information;
identifying a first original motion vector that represents magnitude and direction of displacement from a first area in an image of a first frame of video information to a second area in an image of a second frame of video information;
identifying a second original motion vector that represents magnitude and direction of displacement from a third area in the image of the second frame of video information to a fourth area in an image of a third frame of video information, wherein the third area overlaps only a portion of the second area;
deriving a new motion vector not present in the video data stream from the first original motion vector and the second original motion vector, wherein the new motion vector represents magnitude and direction of displacement from a source area to a destination area in images of two frames in the sequence of frames of video information, wherein the new motion vector is derived such that either:
the source area overlaps only a portion of the first area and the degree to which the source area overlaps the first area is controlled the degree to which that portion of the second area overlaps the third area, and the destination area overlaps only a portion of the fourth area and the degree to which the destination area overlaps the fourth area is controlled by the degree to which that portion of the second area overlaps the third area, or
the source area overlaps only a portion of the fourth area and the degree to which the source area overlaps the fourth area is controlled by the degree to which that portion of the second area overlapped by the third area, and the destination area overlaps only a portion of the first area and the degree to which the destination area overlaps the first area is controlled by the degree to which that portion of the second area overlaps the third area; and
applying signal processing to at least some of the video information to generate a processed signal representing a modified form of at least a portion of the sequence of images, wherein the signal processing adapts its operation in response to the new motion vector.

16. (canceled)

17. The medium of claim 15, wherein the method comprises:
identifying the second original motion vector to establish the third area in the image of the second frame of video information; and
identifying the first original motion vector by identifying a motion vector in the encoded video data stream that has a destination area in the second video frame of information that overlaps the third area.

18. The medium according to claim 15, wherein the method comprises:
identifying video information adjacent to the source and destination areas that can be represented by a motion vector; and
adjusting sizes of the source and destination areas to include the identified video information.

19. The medium according to claim 15, wherein the video data stream conveys some of the frames of video information as intra-frame encoded data and conveys some of the frames of video information as inter-frame encoded data that comprises the original motion vectors, and wherein the destination area is in an image conveyed as intra-frame encoded data.

20. The medium according to claim 15, wherein:
the sequence of video frames is arranged in groups of frames, each group having one frame conveying video information as intra-frame encoded data and a plurality of frames conveying video information as inter-frame encoded data; and
the source and destination areas are in images of two video frames in different groups of frames.

21. The medium according to claim 15, wherein the signal process is any one of image noise reduction, image resolution enhancement and video data compression.
